(19) United States
(12) Patent Application Publication
(10) Pub. No.: US 2014/0365396 A1
(43) Pub. Date: Dec. 11, 2014

(54) COMPUTER IMPLEMENTED SYSTEM AND METHOD FOR FACILITATING A BOARD MEETING

(71) Applicant: Tata Consultancy Services Limited, Mumbai (IN)

(72) Inventors: Alok KUMAR, Mumbai (IN); Bhadresh VYASA, Mumbai (IN); Darshan Dipak MHATRE, Mumbai (IN); Chaitanya SHAH, Mumbai (IN)

(73) Assignee: Tata Consultancy Services Limited, Mumbai (IN)

(21) Appl. No.: 14/218,838

(22) Filed: Mar. 18, 2014

(30) Foreign Application Priority Data
Jun. 6, 2013 (IN) 1960/MUM/2013

(51) Int. Cl. G06Q 10/10; G06F 17/24

(52) U.S. Cl. CPC G06Q 10/10; G06F 17/241
USPC 705/345

(57) ABSTRACT

The present disclosure generally relates to systems and methods for facilitating a meeting, and more particularly, to systems and methods for facilitating a board meeting using a portable device. In one embodiment, a method for facilitating a meeting is disclosed, comprising: providing a Graphical User Interface customized for a meeting member, wherein the Graphical User Interface is capable of displaying meeting details as one or more navigable images; enabling searching for the meeting details or one or more encrypted documents based on at least one of a search string or a voice command; receiving one or more annotations from one or more other meeting members relating to the meeting details or the one or more documents; and facilitating communication among at least two of the meeting members using at least one of: an email, an online chat, or sharing of a display of the portable device.

### PRIORITY CLAIM

This U.S. patent application claims priority under 35 U.S.C. §119 to India Provisional Patent Application No. 1960/MUM/2013, filed on Jun. 6, 2013. The aforementioned application is incorporated herein by reference in its entirety.

### TECHNICAL FIELD

The present disclosure generally relates to systems and methods for facilitating a meeting, and more particularly, to systems and methods for facilitating a board meeting using a portable device.

### BACKGROUND

Board meetings today often take place within confined walls of board rooms at organizations' facilities. To facilitate the board meeting, a company secretary, along with board members, may have to be physically present in the board rooms. In a typical board meeting, the company secretary may be responsible for coordinating activities associated with the meeting and also responsible for taking notes and/or writing down key points discussed in the board meeting. However, since the board meeting is conducted offline, many challenges exist in the proceeding, managing, and execution of the activities associated with the meeting.

One of the challenges in the existing process of conducting the board meeting includes managing reams of documents associated with the meeting. Further, to note down important points discussed in the meeting, the company secretary and/or board members may take prints of the presentations, word-processing documents, etc. The prints may be misplaced, leading to wastage of resources as well as increased efforts by the board members in compiling the meeting details. This may further lead to re-printing of the documents or re-work on the similar points. Therefore, in the current context of facilitating a board meeting, lot of time and efforts may be required in coordination, collaboration, searching, and retrieving of details associated to the meeting.

Another challenge includes maintaining privacy and/or confidentiality of the content of the documents associated with the meeting. Because the meeting is usually facilitated offline, there is a challenge of preventing the documents from unauthorized access. Specifically, the physical documents may be susceptible to unauthorized/intrusive access or usage. Such unauthorized/intrusive access or usage may be against the security and/or confidentiality policies of the organization. Further, there is a likelihood of leakage of information, such as organizations' performance, future plans, important credentials, decisions taken in the meetings, etc., due to a breach of confidentiality and/or security.

Another challenge includes accessing and/or reviewing physical documents by the board members to prepare for the meeting. Further, because the board members may be required to manually review the documents, any changes/amendments made in the documents after the review or during the meeting may be error prone and non-traceable. Further, no provision may exist for the board members to track the changes/amendments made by any of the board members. Additionally, it may be cumbersome and tedious for the board members to search for the documents, agendas and other details associated to the meeting.

### SUMMARY

This summary is provided to introduce aspects related to systems and methods for facilitating a meeting, and the aspects are further described below in the detailed description. This summary is not intended to identify essential features of the claimed disclosure nor is it intended for use in determining or limiting the scope of the claimed disclosure.

In one implementation, a system for facilitating a meeting is disclosed, comprising: one or more processors; and a memory storing processor-executable instructions that, when executed by the one or more processors, configure the one or more processors to: provide a Graphical User Interface customized for a meeting member, wherein the Graphical User Interface is capable of displaying meeting details as one or more navigable images; enable, via the Graphical User Interface, searching for the meeting details or one or more encrypted documents based on at least one of a search string or a voice command; receive, via the Graphical User Interface, one or more annotations from one or more other members relating to the meeting details or the one or more documents; and facilitate communication among at least two of the meeting members using at least one of: an email, an online chat, or sharing of a display of the portable device.

In one embodiment, a method for facilitating a meeting is disclosed, comprising: providing, by one or more hardware processors executing programmed instructions stored in a memory of a portable device, a Graphical User Interface customized for a meeting member, wherein the Graphical User Interface is capable of displaying meeting details as one or more navigable images; enabling, via the Graphical User Interface, searching for the meeting details or one or more encrypted documents based on at least one of a search string or a voice command; receiving, via the Graphical User Interface, one or more annotations from one or more other meeting members relating to the meeting details or the one or more documents; and facilitating communication among at least two of the meeting members using at least one of: an email, an online chat, or sharing of a display of the portable device.

In one embodiment, a non-transitory computer readable medium having embodied thereon computer program instructions for facilitating a meeting, the computer program instructions comprising instructions for configuring a processor to perform operations comprising: providing a Graphical User Interface customized for a meeting member, wherein the Graphical User Interface is capable of displaying meeting details as one or more navigable images; enabling, via the Graphical User Interface, searching for the meeting details or one or more encrypted documents based on at least one of a search string or a voice command; receiving, via the Graphical User Interface, one or more annotations from one or more other meeting members relating to the meeting details or the one or more documents; and facilitating communication among at least two of the meeting members using at least one of: an email, an online chat, or sharing of a display of a portable device.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network environment including a system for facilitating a meeting, in accordance with an embodiment of the present disclosure.

FIG. 2 illustrates an exemplary system for facilitating a meeting, in accordance with an embodiment of the present disclosure.

FIG. 3 illustrate an exemplary application panel module, in accordance with an embodiment of the present disclosure

FIG. 4 illustrate an exemplary meeting management module, in accordance with an embodiment of the present disclosure.

FIG. 5 illustrate an exemplary security management module, in accordance with an embodiment of the present disclosure.

FIG. 6 illustrate an exemplary service architecture of the system for facilitating a meeting, in accordance with an embodiment of the present disclosure.

FIG. 7 illustrate an exemplary service architecture defining a plurality of meeting management services facilitated by the system for facilitating a meeting, in accordance with an embodiment of the present disclosure.

FIG. 8. illustrate an exemplary sequence diagram of the system for facilitating a meeting, in accordance with an embodiment of the present disclosure.

FIG. 9 illustrates an exemplary method for facilitating a meeting, in accordance with an embodiment of the present disclosure.

### DETAILED DESCRIPTION

Systems and methods for facilitating a meeting are described. A system may provide an improved and secured Graphical User Interface (GUI) for conducting a meeting. The system may also provide a plurality of functions to a member. The functions may include providing meeting materials, agenda and attendee information, details of past, present, and future meetings, etc. The member may be provided with a personalized log-in screen. The log-in screen may be animated and refreshing. For example, the log-in screen may display animated zooming-in and zooming-out images of an organization's facilities. The user interface may comprise a list of annotations on the screen. Each annotation may be represented in a visual format that may be easily understood to the members of the meeting. Each annotation may be accessed via a touch input by the member on the GUI. The member may be allowed to delete any annotation from the list. The annotation may be enabled through a sticky note or a free-draw platform, a highlighter tool, an audio/video recording module, and a bookmarking module. The annotations may be shared and viewed by other members. The members may view the annotations with the screen number/ID by one touch of the list view option that is showing on the GUI.

In one embodiment, the GUI may enable the members to search for a particular screen in the document. Further, the GUI may facilitate the member to just flip through a plurality of screens and locate the required screens. However, when the member is aware of the specific screen ID/Number, the member may directly type the screen ID/Number in a search option that is showing on the GUI to locate the specific screen. In one embodiment, the system may help the members in understanding the GUI using a contextual help option that is showing on the screen. The member may be provided with a personalized way of viewing any document based on the agenda selected. In some embodiments, only one document may be attached to the agenda selected. The member may be directed to the last accessed screen when the document is opened and the last accessed screen may be saved while viewing the document.

In one embodiment, the system may provide a pull-down ribbon option on the GUI for viewing the agendas related to the meeting. The pull-down ribbon may comprise one or more documents categorized based on the agenda of the meeting. The member may be enabled to switch the accessing of one document to another document by selecting the agenda of the meeting displayed on the pull-down ribbon. Specifically, the pull-down ribbon may enable the members to switch from one document to another that is to be discussed in the meeting. To switch the viewing among the documents, the members may need to tap on the pull-down ribbon and select the agenda corresponding to which the documents need to be reviewed by the members. The pull-down ribbon may comprise a ribbon metaphor with a downward arrow and may have a visual affordance of pulling out, which makes it easier for the members to realize that a list of documents may appear when the members tap on it. The members may select the required document by tapping on the pull-down ribbon. Similarly, when the members wish to exit from the pull-down ribbon option, the members may tap again on the pull-down ribbon or any other location on the screen. In one embodiment, the system may provide a bookmark option on the GUI.

In one embodiment, the system may provide a calendar interface on the GUI to enable the members to view a list of meetings. As one example, the meetings scheduled for a month may be displayed and the scheduled meetings may appear with animation and color coding based on the status of the organization as, for example, eithera parent or a subsidiary. The calendar interface may be personalized based on the member's profile. The member may have a unique experience of navigating subsidiaries based on a world-map. Further, a subsidiary may be mapped to the world-map based on a geographical position associated to the subsidiary. In one embodiment, the system may enable the member to take screenshots of any screen of the document. The screenshots may be shared via email or an online chat to the other members associated to the meeting. Further, the system may provide, on the GUI, a contact list containing a list of all the members and the details associated to each member. In one embodiment, the system may further enable the member to share the display screen of the portable device with other members that are present in the meeting. In one embodiment, the system may enable the member to search for any document and other details associated with the meeting. In one embodiment, the system may be enabled to capture a list of attendees and a number of the attendees in the meeting for future reference. Further, the system may be enabled to capture information on frequently asked questions (FAQs), news reports, and minutes of meeting (MoM), etc. The system may further enable the members to upload, in a real time, a new document into the repository. The uploading of the new document may generate a notification alert for at least one other member.

In one embodiment, the system may enable a customized multi-tenant implementation for facilitating the meetings based upon a target organization's requirements. The customization may typically include the aspects of branding and access control. The branding may allow each organization to customize the look-and-feel of the GUI to match with the corporate branding (often referred to as a distinct “skin”) of each client organization (also referred as a tenant). The access control may facilitate each client organization to independently customize access rights and restrictions for respective members. The tenants may be provided with the same thick-client application instance, which may connect to the same client service instance running on the application server instance of the system. Each tenant may have a separate database schema and a separate folder for document store. The member details associated with each tenant may be stored in a common database schema. In one aspect, if the members of application are common for more than one company tenant, the members may use the same application server instance to access the required documents.

While aspects of described system and method for facilitating a meeting may be implemented in any number of different computing systems, environments, and/or configurations, the embodiments are described in the context of the following exemplary system.

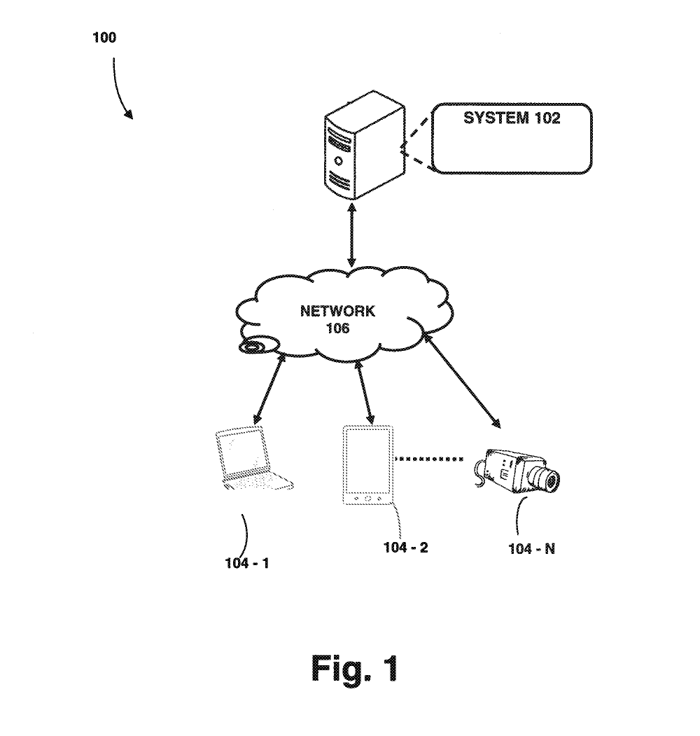

Referring now to FIG. 1, an exemplary network environment 100 including a system 102 for facilitating a meeting is illustrated, in accordance with an embodiment of the present disclosure. In one embodiment, the system 102 may be configured to provide, on a portable device associated with a member, a Graphical User Interface (GUI) customized based on the preferences of the member. The GUI may be capable of displaying details associated with the meeting after the member is securely logged into the GUI using login credentials. The details may comprise calendar information, date panel, agenda of the meeting, and attendee information. The details may be displayed in form of one or more customized images. The member may be enabled to navigate from one image to another via the GUI. The system 102 may be configured to enable the member, via the GUI, to search for the details or one or more documents stored in a repository. The details or the one or more documents may be searched based on a search string or a voice command received from the member. The one or more documents may be encrypted using an encryption key. The member may be enabled to access the one or more documents using a decryption key. Further, the member may be enabled to switch the accessing of one document to another document via a pull-down ribbon that is showing on the GUI. The system 102 may be configured to receive, on the GUI, one or more annotations from one or more members present in the meeting. The one or more annotations are with respect to the details or with respect to the one or more documents. Each annotation may be in a form of at least one of a video, an audio, a text, a highlighted text, and a bookmark. The one or more annotations may be listed in a form of a scrollable list at a pre-defined location of the GUI. In one embodiment, the member may access each of the annotations in the scrollable list via a touch input on the GUI. The system 102 may be configured to facilitate communication among the members using communication means that include at least one of an email, an online chat, or sharing of a display screen of the portable device among members.

Although the present disclosure is explained considering that the system 102 is implemented as a server, it is appreciated that the system 102 may also be implemented in a variety of computing systems, such as a laptop computer, a desktop computer, a notebook, a workstation, a mainframe computer, a network server, etc. In one embodiment, the system 102 may be implemented in a cloud-based environment. It is appreciated that the system 102 may be accessed by multiple members through one or more portable devices 104-1, 104-2, . . . 104-N, collectively also referred to as portable devices 104 or interchangeably a portable device 104 hereinafter, or applications residing on the portable devices 104. Examples of the portable devices 104 may include, but are not limited to, a portable computer, a personal digital assistant, a handheld device, a tablet computer, a smartphone, etc. The portable devices 104 may be communicatively coupled to the system 102 through a network 106.

In one implementation, the network 106 may be a wireless network, a wired network or a combination thereof. The network 106 may be implemented as one of the different types of networks, such as intranet, local area network (LAN), wide area network (WAN), the Internet, etc. The network 106 may either be a dedicated network or a shared network. The shared network may represent an association of the different types of networks that use a variety of protocols (e.g., Hypertext Transfer Protocol (HTTP), Transmission Control Protocol/Internet Protocol (TCP/IP), Wireless Application Protocol (WAP), etc.) to communicate with one another. Further, the network 106 may include a variety of network devices, including routers, bridges, servers, computing devices, storage devices, etc.

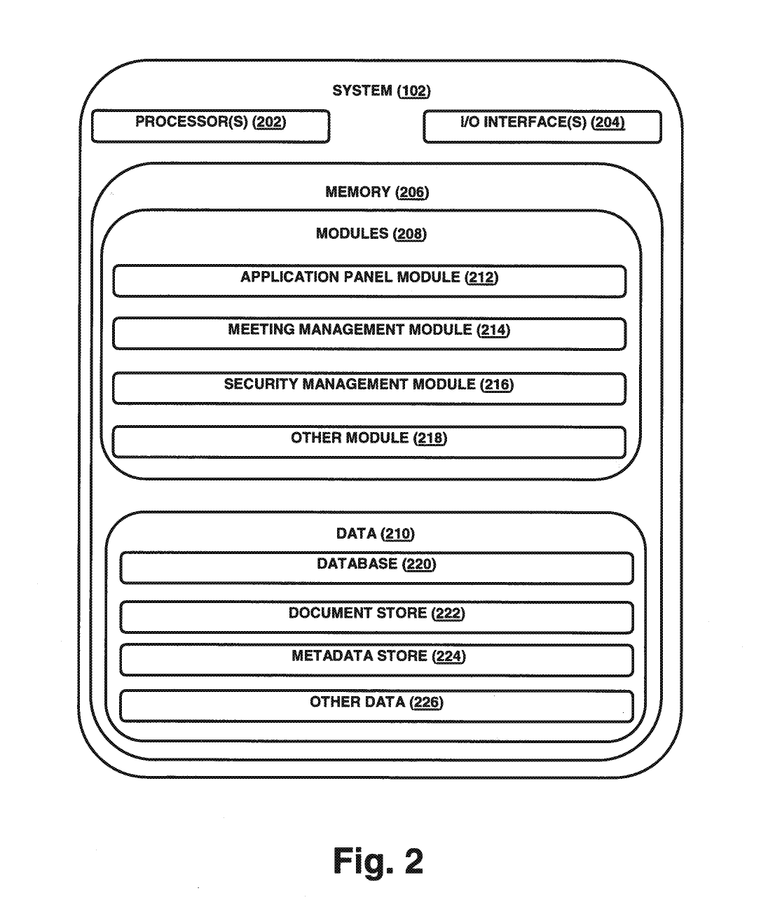

Referring now to FIG. 2, the system 102 is illustrated in accordance with an embodiment of the present disclosure. In one embodiment, the system 102 may include one or more processors 202, an input/output (I/O) interface 204, and a memory 206. The one or more processors 202 may be implemented as one or more microprocessors, microcomputers, microcontrollers, digital signal processors, central processing units, state machines, logic circuitries, and/or any devices that manipulate signals based on operational instructions. Among other capabilities, the one or more processors 202 may be configured to fetch and execute a set of instructions stored in the memory 206.

The I/O interface 204 may include a variety of software and hardware interfaces, for example, a web interface, a graphical user interface, etc. The I/O interface 204 may allow the system 102 to interact with a member directly or through the portable devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks (e.g., LAN, cable networks, etc.) and wireless networks (e.g., WLAN, cellular networks, or satellite networks). The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one embodiment, the modules 208 may include an application panel module 212, a meeting management module 214, a security management module 216, and other module 218. The other module 218 may include programs or coded instructions that supplement applications and functions of the system 102.

The data 210, among other things, may serve as a repository for storing data processed, received, and generated by one or more of the modules 208. The data 210 may also include a database 220, a document store 222, a metadata store 224, and other data 226. The other data 226 may include data generated as a result of the execution of one or more modules in the other module 218.

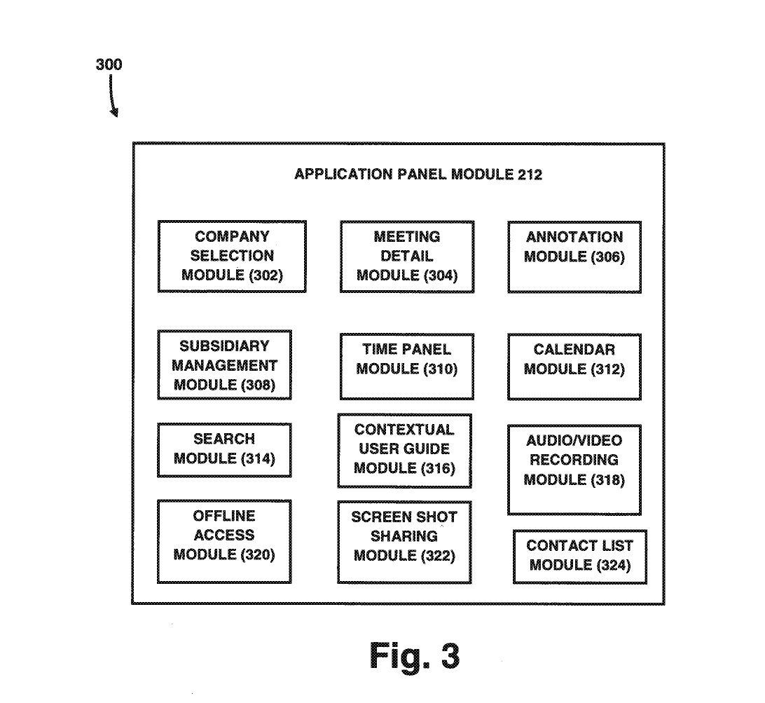

In one embodiment, at first, the member may use one of the portable devices 104, hereinafter referred as a portable device 104, to access the system 102 via the I/O interface 204. The member may register themselves using the I/O interface 204 to use the system 102. The operation of the system 102 based on the plurality of modules 208 is further explained in connection with FIGS. 3-10.

FIG. 3 illustrates an exemplary operation of the application panel module 212. As shown in FIG. 3, the application panel module 212 may comprise a company selection module 302, a meeting detail module 304, an annotation module 306, a subsidiary management module 308, a time panel module 310, a calendar module 312, a search module 314, a contextual user guide module 316, an audio/video recording module 318, an offline access module 320, a screen shot sharing module 322, and a contact list module 324. The company selection module 302 may be configured to enable the member to select one of a plurality of organizations displayed on the GUI of the portable device 104, and view the meeting scheduled for the selected organization. The member may be mapped with a plurality of organizations, either parents or subsidiaries. In one embodiment, when the member is mapped with more than one organization, the member may be provided with the plurality of organizations that are mapped against the member's profile. The plurality of organizations may be displayed on the portable device 104 when the member is logged-in to the system 102 using the login credentials. The member, via the company selection module 302, may then select one of the mapped organizations to view the meeting scheduled corresponding to the selected organization. The meeting detail module 304 may be configured to display details associated with the meeting scheduled for the member. The details may comprise, for example, calendar information, a date panel, an agenda of the meeting, and attendee information. In one example, the calendar information may include at least one of a meeting date, the name of the organization, a number of the members, the names of the members, the meeting location, the status of the organization as one of a parent or a subsidiary, the name of the parent when the organization is subsidiary, and a number of documents pertaining to the meeting. In one embodiment, the member may be enabled to annotate the details or the one or more documents associated with the meeting using the annotation module 306.

In some embodiments, the annotation module 306 may be configured to enable the member to annotate the details and the one or more documents by providing a plurality of platforms. The annotation module 306 may be configured to provide a stick note platform to enable the member to create sticky notes. Sticky notes may be created over at least one document associated with the meeting. The sticky notes may help the member to write important points as desired. The member may store the sticky notes at a desired location over the at least one document for future reference. In one example, the sticky notes may be used to write a to-do list, a phone number, or any other point discussed in the meeting. Further, the annotation module 306 may be configured to provide a free-draw platform to enable the member to write notes in his or her hand. In some embodiments, the member may be provided with options of five different colors and different sizes ranging from 1 to 5 to write the notes using the free-draw platform. The member may either save or undo their writings with the options available at the top of the screen.

Further, the annotation module 306 may be configured to provide a highlighter tool in order to enable the member to highlight a text in the document. Highlighting of the text based on the highlighter tool may help to mark or indicate that the highlighted text is important. Highlighting can be beneficial for future references and for follow-ups after the meeting. In one embodiment, the highlighter tool may enable the member to highlight the text in different sizes and with different colors. In one example, a default color for the highlighting of the text may be yellow, because most of the members may prefer highlighting the text using the yellow color. The annotation module 306 may further be configured to enable the member to annotate the details or the one or more documents by recording a note and/or a comment associated to the document using an audio/video recording module 318. The audio/video recording module 318 may facilitate the member to record, via a single tap on the GUI, the member's voice and/or record a video over a document. The recorded voice and/or video may be stored in the database 220. The recorded voice and/or video may be replayed later as desired. The recording of the voice and/or video may reduce the efforts of taking notes and may help the member to avoid missing some points.

In one embodiment, the annotation module 306 may be configured to enable the member to bookmark the contents associated with the meeting. The bookmarking of the contents may generate at least one of a bookmarked screen, a bookmarked document, a bookmarked section of the document, a bookmarked calendar, and bookmarked contact details. The bookmark may act as an additional annotation for the members of the meeting. In one embodiment, the annotation module 306 may be configured to list the annotations that include the text, the highlighted text, the audio, the video, and the bookmark on the GUI of the portable device 104. Each annotation may be represented in a visual format that may be easily understood to the members of the meeting. The member may access each annotation via a touch input on the GUI. The member may be allowed to delete any annotation from the list.

The subsidiary management module 308 may be configured to manage information associated with one or more subsidiaries of a parent organization. Specifically, the subsidiary management module 308 may be configured to map a subsidiary with a corresponding parent company. Further, depending on the parent company of the subsidiary, each subsidiary may be represented by a unique color code on the display of the portable device 104. The representing of the subsidiary by the unique color code may enable the member to intuitively and quickly identify the subsidiary, whose meeting details may have to be reviewed. Further, the subsidiary management module 308 may be configured to map meetings of the subsidiaries corresponding to said subsidiaries. The member may have a unique experience of navigating subsidiaries based on a world-map. Further, each subsidiary may be mapped to the world-map based on a geographical position associated with the subsidiary. The time panel module 310 may be configured to display a current time, a planned time for the scheduled meetings, and time associated to the previous meetings. The calendar module 312 may be configured to display the calendar information on the GUI of the portable device 104.

In one embodiment, the calendar module 312 may be configured to display, on the GUI of the portable device, a list of meetings scheduled for the member. As one example, the meetings scheduled for a month may be displayed. The meetings scheduled may be displayed in a customized animated format along with a unique color code, which depends on the status of the organization as one of a parent or a subsidiary. Further, the calendar module 312 may display the number of meetings and the name of the parent or the subsidiary whose meeting is scheduled on a particular date. As one example, the date of the system 102 may be highlighted in bold black. In one embodiment, tapping on any date may provide details associated with the meeting. The details may include the name of the committee, the location that the meeting is scheduled, the name of the parent company and the number of documents attached to the meeting. In one embodiment, the calendar module 312 may enable the member to toggle or navigate between multiple meetings. The ease of navigation may help the member to get a view of the calendar in a periodic format, e.g. a weekly view, a monthly view, and a yearly view, etc. All the meetings may be viewed on a single screen using the calendar module 312. The GUI that displays the calendar information may be personalized based on the member's profile. The view of the meetings in a periodic format may enable the member to have an easy access of the meetings scheduled in the future. Further, the calendar module 312 may be configured to provide a personalized scrollable date panel, which may enable the member to navigate details associated with a meeting for a specific date and a specific committee.

In one embodiment, the search module 314 may be configured to enable the member to search for the details or one or more documents associated with the meeting. The search may be performed based on parameters that include date, meeting, company, and committee. Based on the search performed, the search results may be provided to the member on the GUI of the portable device 104. The search results may be made visually consistent with the other screens for easy recognition and comprehension. The search results may follow the visual metaphor for the documents, the meetings, and the circulars for better understanding. In one embodiment, the search module 314 may enable the performing of a voice based search, which may help the member to search a document by tapping on a search button on the GUI and speaking the document name. The speaking of the document name may enable the audio/video recording module 318 to record the voice and trigger the search module 314 to search the document based upon the document name. The contextual user guide module 316 may be configured to help the member to understand the functionalities, features and capabilities of the system 102 that facilitates the meeting. The contextual user guide module 316 may provide a contextual help tab on the GUI of the portable device. The contextual help tab may represent a transparent overlay based and a highly context sensitive help screen, which describes a plurality of fields/options that are present on the GUI. The transparent overlay may have arrows and may indicate that the context and description make it simpler for the member to correlate with the fields/options on the GUI.

In one embodiment, the offline access module 320 may be configured to enable the member to work offline when the system 102 is not connected to the portable device 104. Specifically, when there is no network connection between the portable device 104 and the system 102, the member may view the details and the documents associated with the meetings in an offline mode. And when the network connectivity is restored or when the system is in an online mode, the activities performed by the member in the offline mode may be synchronized with the system 102 automatically. As one example, the member may annotate a document when the member is viewing the system 102 in the offline mode. Further, the annotated document may be reflected after the system 102 is in the online mode. Specifically, the offline access module 320 may provide the member feasibility to work in one of an online mode or an offline mode, such that one or more activities performed by the member in the offline mode are synchronized with the system 102 once the member switches to the online mode from the offline mode.

In one embodiment, the screen shot sharing module 322 may be configured to enable the member to share a screen shot of the display screen of the portable device to other members present in the meeting. In one example, the screen shot sharing module 322 may enable the member to take screenshot of a screen of a document which may be shared easily via email or an online chat to other member present in the meeting. In one implementation, the screenshot of the document may be captured using a camera installed in the portable device. The contact list module 324 may be configured to display, on the GUI, a contact list that contains a list of all the members and the contact details associated with each member. As one example, the contact details may comprise a name, a contact number, an email ID, a residential/official address, and a photo. The details may help in facilitating quick communications between the members that are present in the meeting.

In one embodiment, the members may communicate among each other using a chat module (not shown in FIG. 3). The members may further initiate a group chat, via the chat module, to discuss with more than one member simultaneously. The chat module may be configured to save a chat history in the database 220. The chat history may comprise name and date under Group Discussion, making it easy for the member to search for the desired chat from the database 220. Further, the members may communicate among each other using a video conferencing platform, which enables the members to conduct the meeting from disparate locations across the globe. In one embodiment, the system 102 may display a location of the member on the GUI of the portable device 104. The location may be identified using a Global Positioning System (GPS) sensor that is installed in the portable device. The location is accessible to the other members present in the meeting.

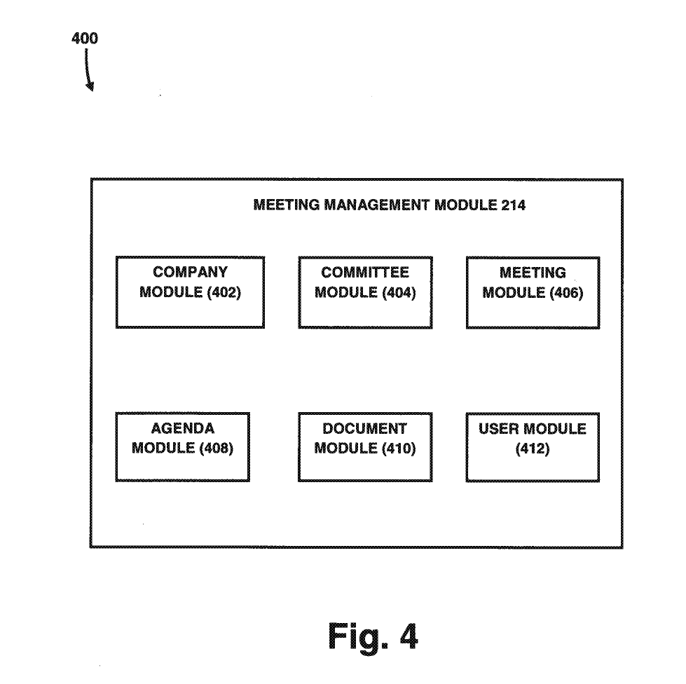

FIG. 4 illustrates an exemplary meeting management module 214, in accordance with an embodiment of the present disclosure. In an embodiment, as shown in FIG. 4, the meeting management module 214 may further comprise a company module 402, a committee module 404, a meeting module 406, an agenda module 408, a document module 410, and a user module 412. The company module 402 may be configured to enable the member to add/edit a company (e.g., a subsidiary or a parent) or deactivate a company (e.g., a subsidiary), if required. Further, the company module 402 may be configured to display a company list that may include all the companies. Each company in the company list may be classified either as a parent or a subsidiary. The members may be able to sort the companies using a company filter based on the active/inactive status or geographical position of the company. The committee module 404 may be configured to enable the member to add/edit/deactivate a committee. Further, the committee module 404 may be configured to display a committee list that may include all the committees. The members may be able to sort the committees using committee filter based on active/inactive status.

The meeting module 406 may be configured to enable the member to add/delete a meeting. In some embodiments, on deletion of the meeting, agenda and documents corresponding to the meeting may also be deleted. The meeting module 406 may enable the member to edit all the existing details of the meeting. The member may be enabled to select any date from the date panel to view scheduled meetings corresponding to the date selected. The meeting module 406 may be configured to display meetings scheduled for the current month. In one embodiment, a specific committee may be mapped to a specific company. Further, specific members may be mapped to a combination of company and committee. In one embodiment, when the member selects a specific date from the date panel using the calendar module, a list of scheduled meetings corresponding to the specific date may be displayed to the member.

In one embodiment, the meeting module 406 may enable the user to send at least one invitation for any particular meeting. The invitation may be sent in the form of an email. The meeting module 406 may further provide a circular interface for enabling the user to upload circulars and/or documents associated with the circulars. In an embodiment, the documents associated with the circulars may be uploaded in an encrypted form. The circular interface may enable the user to respond to clarifications raised by a board of directors. Further, the circular interface may facilitate the board of directors to approve and/or withdraw the circulars. The circular interface may facilitate a company secretary (CS) team to ease the task of issuing the memo with required documents to all corresponding committee members. The CS team may be enabled to track the members who have approved and/or withdrawn the circulars. In one embodiment, a specific circular may be considered to be passed if the majority of the members have approved the said circular. The board/committee members may access the circulars that are issued to them from remote location and can make necessary decisions on the said circulars.

The agenda module 408 may be configured to enable the member to add/edit/delete an Agenda. While creating a new agenda, the member may select a matter, an agenda item, a sort number, and an access privilege. The member may store documents related to the agenda in the document store 222 (shown in FIG. 2) using the document module 410. The documents may be encrypted with an encryption key while storing the document in the document store 222. The member may be provided with an “add document link,” which may be used when the member wants to upload and/or store the document after the creation of an agenda. The member may be enabled to click the “add document link” on the agenda list to upload the documents. To replace the existing document with a updated one, the member may replace the document link on the agenda details. Accordingly, a new document may be stored in the document store 222. In one embodiment, the document store 222 may comprise encrypted or password protected documents of different types including, but not limited to PDF, Microsoft Word, Microsoft PowerPoint Presentation, etc. The members may refer each of the documents concurrently and annotate the documents. Further, metadata associated to the documents in the document store 222 may be stored in a metadata store 224. The metadata may be related to the content present in each of the documents stored in the document store 222. The user module 412 may be configured to map the members to any company-committee combination. The user module 412 may be enabled to display a member list that comprises one or more members authorized to view meetings corresponding to a respective company-committee combination. Each member may be mapped to a company and a committee. The member may be enabled to delete one of the members from the member list.

In one embodiment, the meeting management module 214 may further be configured to allow the user to enable/disable a plurality of functionalities that are facilitated through one or more modules. For example, the meeting management module 214 may be configured to enable and/or disable the chat module, the video conferencing platform, the circular interface, and the contact list module, thereby enabling/disabling the functionalities of the online chat, the video conferencing, tracking of circular workflows, and accessing the contact details of the members, respectively.

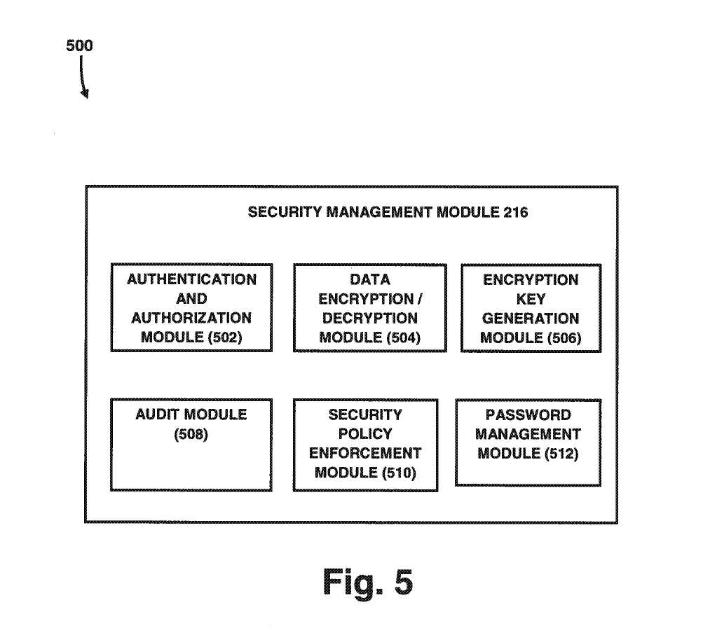

FIG. 5 illustrates an exemplary security management module 216, in accordance with an embodiment of the present disclosure. As shown in FIG. 5, the security management module 216 may comprise an authentication and authorization module 502, a data encryption/decryption module 504, an encryption key generation module 506, an audit module 508, a security policy enforcement module 510, and a password management module 512. The authentication and authorization module 502 may be configured to enable the member to authenticate based on credentials such as user ID and password. A client service may be configured to perform the authentication and authorization of the member on the system 102. The data encryption/decryption module 504 may be configured to encrypt the documents stored in the document store 222. The documents may be encrypted using an encryption key generated by the encryption key generation module 506. The audit module 508 may be configured to capture and/or record log of activities performed by the member. The log may be captured in a log file which may be referred for auditing purpose. The security policy enforcement module 510 may be configured to provide a plurality of security related policies as per the organization/company's standards. The password management module 512 may be configured to enable the member to organize and/or manage password that allows secured logon to the system 102. Each member may be assigned a role selected from a group comprising a board member, a company secretary, a finance personal, and an administrator. The role may be assigned with unique privilege authorization rights for accessing the details and the one or more documents.

In one implementation, the access provided by the system 102 may be based on the role assigned to each member. As one example, a Super-User may assign roles to an administrator or an admin as either a company secretary (CS), a finance group 1 (Fin1), or a finance group 2 (Fin2). When the admin is assigned with the role CS, the admin may have privilege to view the documents with the “Document Access privilege=CS and ALL.” In such a scenario, the admin should not be able to access the documents with “Document Access privilege=FIN1 & FIN2”, and such document should be visible as disabled document. Similarly, when the admin is assigned with the role Fin1, the admin may have privilege to view the documents with the “Document Access privilege=FIN1 and ALL.” The member should not be able to access the documents with “Document Access privilege=CS & FIN2,” and such document should be visible as disabled document. Further, when the admin is assigned with the role Fin2, the admin may have privilege to view the documents with the “Document Access privilege=FIN2 and ALL.” The member should not be able to access the document with “Document Access privilege=CS & FIN2”, and such document should be visible as disabled document. Furthermore, when the admin is assigned with the role “ALL” (e.g. for board members of the company), then the admin may have privilege to view and access all the documents.

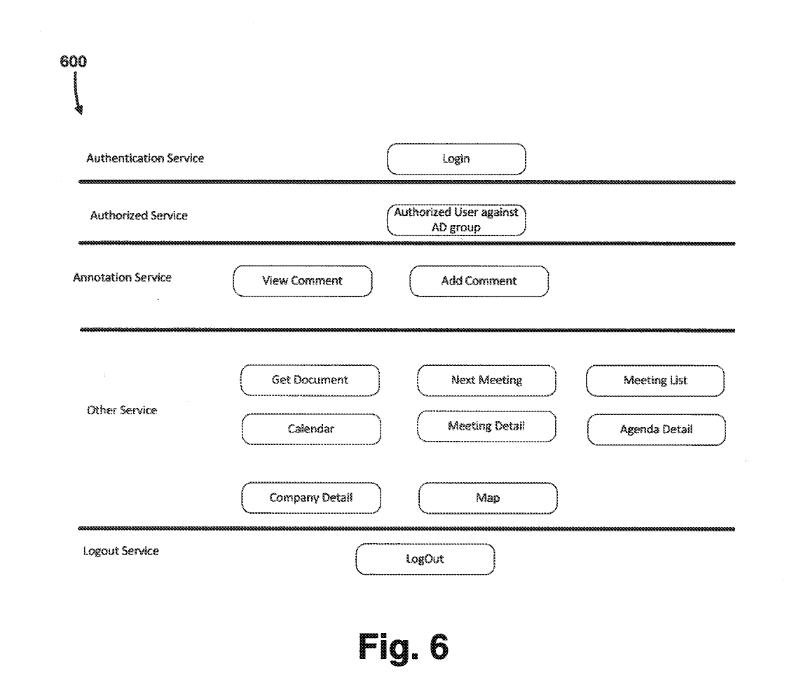

FIG. 6 illustrates an exemplary service architecture of the system 102, in accordance with an embodiment of the present disclosure. As shown in FIG. 6, in one embodiment, the member may login to the system 102 using an authentication service facilitated by the system 102. In one example, the system 102 may authenticate the member based on the login credentials that may include, but not limited to, a user id, a password, etc. After the member is authorized by the system 102, the member may be provided access to one or more services facilitated by the system 102. The one or more services may comprise annotation service and other service. The annotation service may enable the member to view comment, add comment, delete comment, etc. Similarly, the other service facilitated by the system 102 may enable the member to retrieve, for example, a document, a next meeting, a meeting list, a calendar, meeting details, agenda details, company details, a map, etc. The member may be logged out of the system 102 using a logout service.

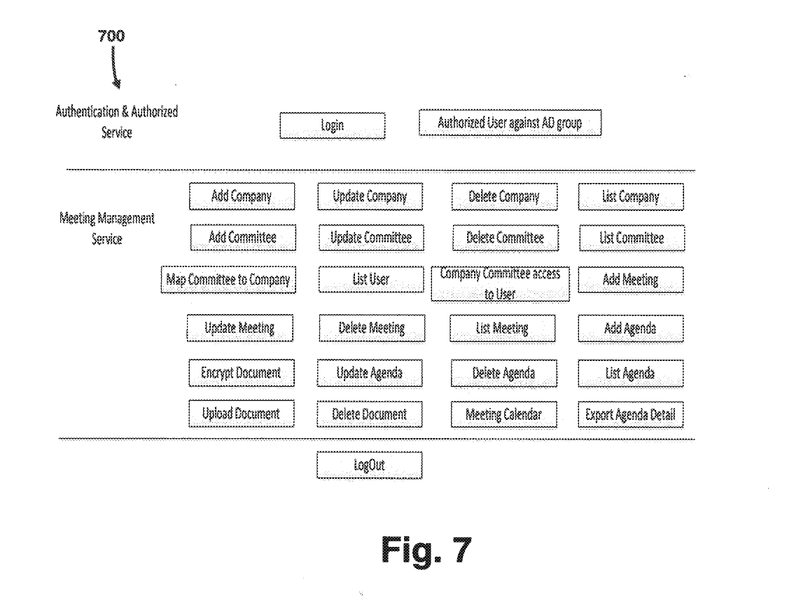

FIG. 7 illustrates an exemplary service architecture 700 defining a plurality of meeting management services facilitated by the system 102, in accordance with an embodiment of the present disclosure.

In one implementation, the member may login to the system 102 using the authentication and authorized service provided by the system 102. After the member is authorized by the system 102, the member may be provided an access to the plurality of meeting management services. The plurality of meeting management services may enable the member to add a company, update a company, delete a company, list a company, add a committee, update a committee, delete a committee, list a committee, map a committee, list a member in the member list, provide a company committee access to a member, add a meeting, update a meeting, delete a meeting, list a meeting, add an agenda, encrypt a document, update an agenda, delete an agenda, list an agenda, upload a document, delete a document, configure a meeting calendar, export agenda details, etc. The member may be logged out of the system 102 using a Logout service.

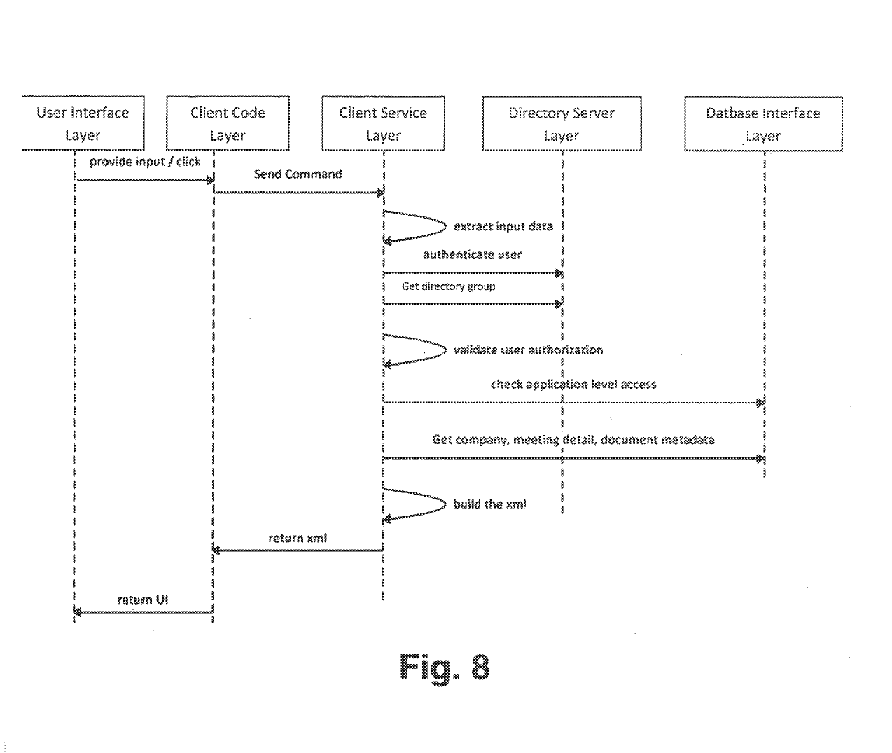

FIG. 8 illustrates an exemplary sequence diagram of the system 102, in accordance with an embodiment of the present disclosure. As shown in FIG. 8, the system 102 may interact with entities such as a user interface layer, a client code layer, a client service layer, a directory server layer, and a database interface layer. In one example, the process may initiate when the member, via the user interface layer, provides input or click on a link to get access to the system 102. The client code layer may receive the request and transmit the information to the client service layer. The client service layer may perform authentication of the member by retrieving directory group corresponding to the member. The directory group may enables to check for the access privileges to be granted to the member. The authentication may be performed using the directory server layer. After the checking of the access privileges, details associated to the meeting may be retrieved using the database interface layer. The details retrieved may comprise company details, meeting details, documents, metadata associated with the documents, and other related information.

Some embodiments of the present disclosure may provide methods and interfaces for the member to access meeting documents with ease, quickly search, and finding the documents with world map, calendar, etc.

Some embodiments of the present disclosure may enable the encryption of confidential documents to avoid unauthorized access and usage of the documents.

Some embodiments of the present disclosure may enable the one or more members to upload, in a real time, a new document into the database, and thereafter generate an alert for at least one other member to notify the uploading of the new document.

Some embodiments of the present disclosure may facilitate corporate boardroom events to be “paper-less”. This may help to sustain the environment by making the need for printed reports redundant. Further, the board members may easily refer to the old meeting documents when desired.

Some embodiments of the present disclosure may enable reduction in manual efforts by the seamless collaboration among board members, which helps in efficient planning and execution of the board meetings.

Some embodiments of the present disclosure may enable a user friendly Graphical User Interface that provides the members with necessary functions at their fingertips. The functions provided may include meeting materials, agenda and attendee information, details of past, present, and future meetings, etc.

Some embodiments of the present disclosure may enable a user friendly view of monthly/yearly calendar for the board members to review schedules and to be informed of details of the future meetings. They board members may be enabled to view the agenda and review the documents of the board meeting.

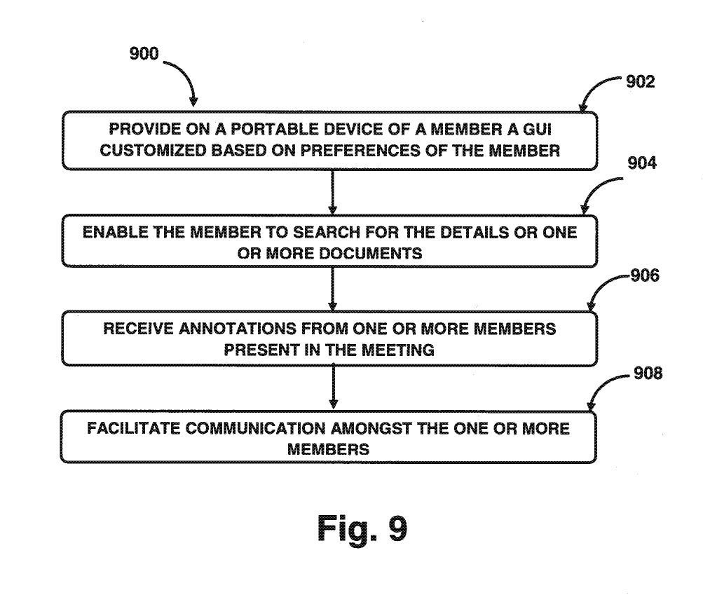

Referring now to FIG. 9, an exemplary method 900 for facilitating a meeting is shown, in accordance with an embodiment of the present disclosure. The method 900 may be described in the general context of computer executable instructions. Generally, computer executable instructions can include routines, programs, objects, components, data structures, procedures, modules, functions, etc., that perform particular functions or implement particular abstract data types. The method 900 may also be practiced in a distributed computing environment where functions are performed by remote processing devices that are linked through a communications network. In a distributed computing environment, computer executable instructions may be located in both local and remote computer storage media, including memory storage devices.

The order in which the method 900 is described is not intended to be construed as a limitation, and any number of the described method steps can be combined in any order to implement the method 900 or alternate methods. Additionally, individual steps may be deleted from the method 900 without departing from the spirit and scope of the disclosure described herein. Furthermore, the method can be implemented in any suitable hardware, software, firmware, or combination thereof. However, for ease of explanation, in the embodiments described below, the method 900 may be considered to be implemented in the above described system 102.

At step 902, a Graphical User Interface (GUI) customized based on preferences of a member may be provided on the portable device associated with the member. The GUI may be capable of displaying details associated with the meeting after the member is securely logged into the GUI using login credentials. In one embodiment, the details may comprise calendar information, date panel, agenda of the meeting, and attendee information. In one embodiment, the details may be displayed in a form of one or more customized images, and the member may be enabled to navigate from one image to another via the GUI.

At step 904, the member may be enabled to search for the details or one or more documents stored in the document store 222. In one embodiment, the details or the one or more documents may be searched based upon a search string or a voice command received from the member. In one embodiment, the one or more documents may be encrypted using an encryption key, and the member may be enabled to access the one or more documents using a decryption key. Further, the member may be enabled to switch the accessing of one document to another document via a pull-down ribbon present on the GUI.

At step 906, annotations from one or more members present in the meeting may be received. Each annotation may be in a form of at least one of: a video, an audio, a text, a highlighted text, and a bookmark. Further, each annotation may be associated with the details or with the one or more documents. The one or more annotations may be listed in form of a scrollable list at a pre-defined location of the GUI. Further, each annotation in the scrollable list may be accessed via a touch input by the member on the GUI.

At step 908, communications among the one or more members may be facilitated. In one embodiment, the communication may be facilitated using communication means comprising at least one of: an email, an online chat, or sharing a display screen of the portable device among the members.

Although implementations for methods and systems for facilitating a meeting have been described in a language specific to structural features and/or methods, it is to be understood that the appended claims are not necessarily limited to the specific features or methods described. Rather, the specific features and methods are disclosed as examples of implementations for facilitating the meeting.

We claim:

1. A method for facilitating a meeting, comprising:
providing, by one or more hardware processors executing programmed instructions stored in a memory of a portable device, a Graphical User Interface customized for a meeting member, wherein the Graphical User Interface is capable of displaying meeting details as one or more navigable images;
enabling, via the Graphical User Interface, searching for the meeting details or one or more encrypted documents based on at least one of a search string or a voice command;
receiving, via the Graphical User Interface, one or more annotations from one or more other meeting members relating to the meeting details or the one or more documents; and
facilitating communication among at least two of the meeting members using at least one of: an email, an online chat, or sharing of a display of the portable device.

2. The method of claim 1, further comprising assigning a role to the meeting member, the role being one of a board member, a company secretary, a finance personal, and an administrator, wherein the role is associated with unique privilege authorization rights for accessing the details and the one or more documents.

3. The method of claim 1, wherein the Graphical User Interface is capable of displaying details after detecting that the meeting member is securely logged in based on login credentials, and wherein the details comprises at least one of: calendar information, a date panel, an agenda of the meeting, and attendee information.

4. The method of claim 3, wherein the calendar information comprises at least one of: a meeting date, a name of the organization, a number of the other meeting members, names of the other meeting members, a meeting location, a status of the organization as one of a parent or a subsidiary, a name of the parent when the organization is subsidiary, and a number of documents associated with the meeting.

5. The method of claim 1, further comprising:
enabling, via the Graphical User Interface, accessing of the one or more documents using a decryption key;
enabling, via the Graphical User Interface, switching from accessing of one of the documents to another of the documents via a pull-down ribbon.

6. The method of claim 5, wherein the pull-down ribbon comprises a listing of one or more documents categorized based on an agenda of the meeting, and wherein the switching from accessing of one of the documents to another of the documents is based on receiving a selection of the agenda of the meeting that is displayed on the pull-down ribbon.

7. The method of claim 1, wherein the one or more annotations are in a form of at least one of: a video, an audio, a text, a highlighted text, and a bookmark, and wherein the one or more annotations are listed in a form of a scrollable list at a pre-defined location of the Graphical User Interface, and wherein the one or more annotations in the scrollable list are accessed via a touch input on the Graphical User Interface.

8. The method of claim 7, further comprising providing a sticky note or a free-draw platform for receiving the text.

9. The method of claim 7, further comprising providing a highlighter tool for receiving the highlighted text.

10. The method of claim 7, further comprising providing an audio or an video recording tool for receiving the audio or the video.

11. The method of claim 7, wherein the bookmark is one of a bookmarked screen, a bookmarked document, a bookmarked section of the document, a bookmarked calendar, or bookmarked contact details.

12. The method of claim 1, further comprising enabling an online mode or an offline mode of operation, wherein one or more activities received in the offline mode operation are capable of being synchronized when the online mode operation is available.

13. The method of claim 1, further comprising enabling uploading, in a real time, a new document, wherein the uploading of the new document generates a notification alert for at least one of the meeting member or one of the other meeting members.

14. The method of claim 1, further comprising displaying a location of the meeting member on the Graphical User Interface, wherein the location is identified using a Global Positioning System sensor of the portable device, and wherein the location is accessible to one or more of the other meeting members.

15. The method of claim 1, further comprising providing sharing of a screenshot of one of the documents, captured using a camera of the portable device, to one or more of the other meeting members.

16. The method of claim 1, further comprising providing a video conferencing platform configured to enable the other meeting members to participate in the meeting from geographical locations other than that of the meeting member.

17. A system for facilitating a meeting, the system comprising:
one or more processors; and
a memory storing processor-executable instructions that, when executed by the one or more processors, configure the one or more processors to:
provide a Graphical User Interface customized for a meeting member, wherein the Graphical User Interface is capable of displaying meeting details as one or more navigable images;
enable, via the Graphical User Interface, searching for the meeting details or one or more encrypted documents based on at least one of a search string or a voice command;
receive, via the Graphical User Interface, one or more annotations from one or more other members relating to the meeting details or the one or more documents; and
facilitate communication among at least two of the meeting members using at least one of: an email, an online chat, or sharing of a display of the portable device.

18. A non-transitory computer readable medium having embodied thereon computer program instructions for facilitating a meeting, the computer program instructions comprising instructions for configuring a processor to perform operations comprising:
providing a Graphical User Interface customized for a meeting member, wherein the Graphical User Interface is capable of displaying meeting details as one or more navigable images;
enabling, via the Graphical User Interface, searching for the meeting details or one or more encrypted documents based on at least one of a search string or a voice command;
receiving, via the Graphical User Interface, one or more annotations from one or more other meeting members relating to the meeting details or the one or more documents; and
facilitating communication among at least two of the meeting members using at least one of: an email, an online chat, or sharing of a display of a portable device.
